(19) United States
(12) Patent Application Publication
(10) Pub. No.: US 2006/0233971 A1
(43) Pub. Date: Oct. 19, 2006

(54) Method of treating inorganic oxide film, electronic device substrate, method of manufacturing electronic device substrate, liquid crystal panel, and electronic apparatus

(75) Inventors: Koichi Terao, Suwa (JP); Yuji Shinohara, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/402,317

(22) Filed: Apr. 11, 2006

(30) Foreign Application Priority Data
Apr. 19, 2005 (JP) 2005-120770

(51) Int. Cl. C09K 19/00

(52) U.S. Cl. 428/1.2

(57) ABSTRACT

A method of treating an inorganic oxide film includes dipping an inorganic oxide film formed by an oblique deposition method having a plurality of pores therein into a treatment liquid containing at least a primary alcohol and a secondary alcohol. The secondary alcohol has a lower molecular weight than that of the primary alcohol. The method also includes reducing pressure of a space where the treatment liquid is provided to infiltrate the treatment liquid into the pores of the inorganic oxide film. Lastly, the method includes chemically bonding the alcohol of the treatment liquid to a surface of the inorganic oxide film and inner surfaces of the pores.

### CROSS-REFERENCE TO RELATED APPLICATIONS

This application claims the benefit of Japanese Patent Application 2005-120770, filed Apr. 19, 2005. The disclosure of the above application is incorporated herein by reference in its entirety.

### BACKGROUND OF THE INVENTION

1. Technical Field of the Invention

The present invention relates to a method of manufacturing an inorganic oxide film, to an electronic device substrate, to a method of manufacturing an electronic device substrate, to a liquid crystal panel, and to an electronic apparatus.

2. Description of the Related Art

In recent years, vertical-alignment-type liquid crystal display devices have been practically used for liquid crystal televisions (direct-view-type display apparatuses), liquid crystal projectors (projection display apparatuses) and the like.

For example, organic alignment films formed of polyimide or the like and oblique deposition films (inorganic oxide films) formed of, for example, SiO₂ are generally used as the vertical alignment films of the vertical-alignment-type liquid crystal display devices. More specifically, the organic alignment films are used for the liquid crystal televisions, and the oblique deposition films are used for the liquid crystal projectors.

The oblique deposition film made of an inorganic oxide has a plurality of pores, and a plurality of polarized hydroxyl groups exist on the surface of the oblique deposition film and the inner surfaces of the pores. This hydroxyl group has activity as a Broensted acid, and is apt to absorb or react with liquid crystal molecules or impurities contained in a liquid crystal display device, particularly, a compound having a polar group.

Examples of these impurities include impurities and unreacted ingredients contained in a sealing material, impurities and water contained in a liquid crystal layer, and dust adhered in the manufacturing process.

It has been known that, when impurities are stuck onto or react with the surface of the oblique deposition film, the shape or polarity of the surface is changed which causes a vertical anchoring force to be weakened. This results in the abnormal alignment of the liquid crystal molecules. It is also known that the liquid crystal molecules may directly react with the hydroxyl group.

In view of these problems, a method of treating the surface of the inorganic oxide film with a higher alcohol or a silane coupling agent has been proposed as a method of reforming the surface of the oblique deposition film (for example, see JP-A-11-160711 and JP-A-5-203958).

In the method disclosed in JP-A-11-160711, an oblique deposition film formed of SiO₂ is exposed to vapor of a higher alcohol. In this method, since a processing temperature is low, the higher alcohol is physically stuck to the oblique deposition film, which results in an excessively weak bonding force. Thus, when coming into contact with the liquid crystal molecules, the higher alcohol is easily separated from the surface of the oblique deposition film, which makes it difficult to obtain a stable vertical alignment force in an initial state.

Further, in the method disclosed in JP-A-5-203958, octadecyl dimethyl(3-(trimethoxysilyl)propyl)ammonium chloride, which is a silane coupling agent, is applied (comes into contact) as a vertical alignment agent on the oblique deposition film formed of SiO₂ which is deposited with the assistance of ion beams. Then, the oblique deposition film is baked at a temperature of 110° C. for one hour.

In this case, however, the pores (openings) have a small diameter, and the mere contact between the silane coupling agent and the oblique deposition film causes only the hydroxyl group on the surface to be chemically bonded. That is, it is difficult to chemically bond the silane coupling agent to the hydroxyl group existing in the pores.

Therefore, the method disclosed in JP-A-5-203958 has a problem in that the alignment of the liquid crystal molecules is deteriorated in a relatively short time due to the influence of the hydroxyl group existing in the pores of the oblique deposition film.

### SUMMARY OF THE INVENTION

In view of the above drawbacks, an aspects of the present invention is to provide a method of treating an inorganic oxide film capable of reliably forming a chemical bond between alcohol and both the surface of the inorganic oxide film and the inner surfaces of pores provided in the inorganic oxide film; an electronic device substrate capable of preventing the alignment of liquid crystal molecules from being deteriorated with the passage of time, a method of manufacturing the electronic device substrate; a liquid crystal panel having high reliability, and an electronic apparatus having high reliability.

According to an aspect of the invention, a method of treating an inorganic oxide film includes dipping an obliquely deposited inorganic oxide film having a plurality of pores formed therein into a treatment liquid containing at least a primary alcohol and a secondary alcohol having a lower molecular weight than that of the primary alcohol; reducing pressure of a space where the treatment liquid is provided to infiltrate the treatment liquid into the pores of the inorganic oxide film; and chemically bonding the alcohol of the treatment liquid to a surface of the inorganic oxide film and inner surfaces of the pores.

In this way, it is possible to reliably form a chemical bond between the alcohol and both the surface of the inorganic oxide film and the inner surfaces of the pores provided in the inorganic oxide film.

According to another aspect of the invention, a method of treating an inorganic oxide film includes bringing a first treatment liquid containing at least a primary alcohol into contact with an obliquely formed inorganic oxide film having a plurality of pores formed therein; chemically bonding the alcohol of the first treatment liquid to a surface of the inorganic oxide film; dipping the inorganic oxide film into a second treatment liquid containing at least a secondary alcohol having a lower molecular weight than that of the primary alcohol; reducing a pressure of a space where the second treatment liquid is provided to infiltrate the second treatment liquid into the pores of the inorganic oxide film; and chemically bonding the alcohol of the second treatment liquid to the surface of the inorganic oxide film and inner surfaces of the pores.

In this way, it is possible to reliably form a chemical bond between the alcohol and both the surface of the inorganic oxide film and the inner surfaces of the pores provided in the inorganic oxide film.

According to still another aspect of the invention, an electronic device substrate includes a substrate; and an alignment film that is formed on a surface of the substrate. In the electronic device substrate, the alignment film is formed by chemically bonding at least a primary alcohol and a secondary alcohol having a lower molecular weight than that of the primary alcohol to a surface of an obliquely formed inorganic oxide film having a plurality of pores formed therein and inner surfaces of the pores.

In this way, it is possible to obtain an electronic device substrate with a high degree of alignment of liquid crystal molecules and an alignment characteristic not deteriorated with the passage of time.

In the electronic device substrate according to this aspect, preferably, a mole ratio of the primary alcohol to the secondary alcohol in the vicinity of the surface of the inorganic oxide film is in the range of 50:50 to 95:5.

In this way, it is possible to improve the alignment of the liquid crystal molecules.

According to yet another aspect of the invention, there is provided a method of manufacturing an electronic device substrate including a substrate and an alignment film formed on a surface of the substrate. The method includes forming an inorganic oxide film having a plurality of pores on the surface of the substrate by an oblique deposition method; dipping the substrate having the inorganic oxide film formed thereon into a treatment liquid containing at least a primary alcohol and a secondary alcohol having a lower molecular weight than that of the primary alcohol; reducing pressure of a space where the treatment liquid is provided to infiltrate the treatment liquid into the pores of the inorganic oxide film; and chemically bonding the alcohol of the treatment liquid to a surface of the inorganic oxide film and inner surfaces of the pores to form the alignment film.

In this way, it is possible to reliably form a chemical bond between alcohol and both the surface of the inorganic oxide film and the inner surfaces of the pores provided in the inorganic oxide film. In addition, it is possible to obtain an electronic device substrate having an alignment film with a high degree of alignment of liquid crystal molecules and an alignment characteristic not deteriorated with the passage of time.

In the method of manufacturing an electronic device substrate according to this aspect, it is preferable that a mole ratio of the primary alcohol to the secondary alcohol of the treatment liquid be in the range of 70:30 to 90:10.

This compound ratio makes it possible to obtain a reliable chemical bond between the primary alcohol and the pores. In addition, it is possible to reliably adjust the ratio of the primary alcohol to the secondary alcohol within the above-mentioned range in the vicinity of the surface of the inorganic oxide film.

In the method of manufacturing an electronic device substrate according to this aspect, it is preferable that, in the infiltrating of the treatment liquid, the pressure of the space be in the range of 1×10⁻⁴ Pa to 1×10⁴ Pa.

In this way, air is reliably removed from the pores of the inorganic oxide film, which makes it possible to infiltrate a sufficient amount of treatment liquid into the pores.

In the method of manufacturing an electronic device substrate according to this aspect, it is preferable that the substrate be heated to chemically bond the inorganic oxide film to the alcohol of the treatment liquid.

The heating makes it possible to easily and reliably perform a reaction between the alcohol of the treatment liquid and the hydroxyl groups existing in the surface of the inorganic oxide film and the inner surfaces of the pores.

In the method of manufacturing an electronic device substrate according to this aspect, it is preferable that the substrate be heated at a temperature of 80° C. to 250° C.

In this way, it is possible to reliably form a chemical bond between the alcohol and the inorganic oxide film, regardless of the kind of alcohol or inorganic oxide.

In the method of manufacturing an electronic device substrate according to this aspect, it is preferable that the substrate be heated for 20 to 180 minutes.

In this way, it is possible to reliably form a chemical bond between the alcohol and the inorganic oxide film, regardless of other conditions, such as a heating temperature.

According to still yet another aspect of the invention, there is provided a method of manufacturing an electronic device substrate including a substrate and an alignment film formed on a surface of the substrate. The method includes forming an inorganic oxide film having a plurality of pores on the surface of the substrate by an oblique deposition method; bringing a first treatment liquid containing at least a primary alcohol into contact with the inorganic oxide film; chemically bonding the alcohol of the first treatment liquid to a surface of the inorganic oxide film; dipping the substrate having the inorganic oxide film formed thereon into a second treatment liquid containing at least a secondary alcohol having a lower molecular weight than that of the primary alcohol; reducing pressure of a space where the second treatment liquid is provided to infiltrate the second treatment liquid into the pores of the inorganic oxide film; and chemically bonding the alcohol of the second treatment liquid to the surface of the inorganic oxide film and inner surfaces of the pores to form the alignment film.

In this way, it is possible to reliably form a chemical bond between alcohol and both the surface of the inorganic oxide film and the inner surfaces of the pores provided in the inorganic oxide film. In addition, it is possible to obtain an electronic device substrate having an alignment film with a high degree of alignment of liquid crystal molecules and an alignment characteristic not deteriorated with the passage of time.

In the method of manufacturing an electronic device substrate according to this aspect, preferably, the first treatment liquid further contains a tertiary alcohol which has a higher molecular weight than that of the secondary alcohol and differs from the primary alcohol and the secondary alcohol in kind.

In this way, it is possible to further strengthen vertical anchoring force with respect to the liquid crystal molecules and thus to reliably align the liquid crystal molecules in the vertical direction.

In the method of manufacturing an electronic device substrate according to this aspect, it is preferable that the substrate be heated to chemically bond the inorganic oxide film to the alcohol of the first treatment liquid.

The heating makes it possible to easily and reliably perform a reaction between the alcohol of the treatment liquid and the hydroxyl groups existing in the surface of the inorganic oxide film and the inner surfaces of the pores.

In the method of manufacturing an electronic device substrate according to this aspect, it is preferable that the substrate be heated at a temperature of 80° C. to 250° C.

In this way, it is possible to reliably form a chemical bond between the alcohol and the inorganic oxide film, regardless of the kind of alcohol or inorganic oxide.

In the method of manufacturing an electronic device substrate according to this aspect, it is preferable that the substrate be heated for 20 to 180 minutes.

In this way, it is possible to reliably form a chemical bond between the alcohol and the inorganic oxide film, regardless of other conditions, such as a heating temperature.

In the method of manufacturing an electronic device substrate according to this aspect, it is preferable that, in the infiltrating of the second treatment liquid, the pressure of the space be in the range of 1×10⁻⁴ Pa to 1×10⁴ Pa.

In this way, air is reliably removed from the pores of the inorganic oxide film, which makes it possible to infiltrate a sufficient amount of treatment liquid into the pores.

In the method of manufacturing an electronic device substrate according to this aspect, it is preferable that the substrate be heated to chemically bond the inorganic oxide film to the alcohol of the second treatment liquid.

In this way, it is possible to reliably react the alcohol with the hydroxyl group included in the inorganic oxide film.

In the method of manufacturing an electronic device substrate according to this aspect, it is preferable that the substrate be heated at a temperature of 80° C. to 250° C.

The heating makes it possible to easily and reliably perform a reaction between the alcohol of the treatment liquid and the hydroxyl groups existing in the surface of the inorganic oxide film and the inner surfaces of the pores.

In the method of manufacturing an electronic device substrate according to this aspect, it is preferable that the substrate be heated for 20 to 180 minutes.

In this way, it is possible to reliably form a chemical bond between the alcohol and the inorganic oxide film, regardless of kinds of alcohol and inorganic oxide film.

In the method of manufacturing an electronic device substrate according to this aspect, it is preferable that the primary alcohol have 5 to 30 carbon atoms.

Even when the alcohol is in a liquid state or a semisolid state (solid state) at room temperature, it can turn to a liquid state at a relatively low temperature. Therefore, when the inorganic oxide film is treated with a treatment liquid, which will be described later, it is possible to easily treat the inorganic oxide film. In addition, since the alcohol having the above-mentioned number of carbon atoms has a high degree of affinity for the liquid crystal molecules, it is possible to reliably strengthen vertical anchoring force with respect to the liquid crystal molecules.

In the method of manufacturing an electronic device substrate according to this aspect, it is preferable that the primary alcohol be an aliphatic alcohol, an alicyclic alcohol, or a fluorine-substituted product thereof.

The use of the aliphatic alcohol, the alicyclic alcohol, or the fluorine-substituted product thereof makes it possible to further strengthen vertical anchoring force with respect to the liquid crystal molecules and thus to reliably align the liquid crystal molecules in the vertical direction.

In the method of manufacturing an electronic device substrate according to this aspect, it is preferable that the alicyclic alcohol have a steroid skeleton.

The alicyclic alcohol having the steroid skeleton or the fluorine-substituted product thereof has a high degree of flatness; it has a good characteristic in controlling the alignment of the liquid crystal molecules.

In the method of manufacturing an electronic device substrate according to this aspect, it is preferable that the secondary alcohol have 1 to 4 carbon atoms.

Since the alcohol having the above-mentioned number of carbon atoms has a small molecular size, it can be reliably infiltrated into the pores.

In the method of manufacturing an electronic device substrate according to this aspect, it is preferable that the secondary alcohol be an aliphatic alcohol or a fluorine-substituted product thereof.

Since the aliphatic alcohol or the fluorine-substituted product thereof has a molecular structure close to a straight line, it can be reliably infiltrated into the pores.

In the method of manufacturing an electronic device substrate according to this aspect, preferably, when the number of carbon atoms of the primary alcohol is referred to as A and the number of carbon atoms of the secondary alcohol is referred to as B, A-B is equal to or larger than 3.

In this way, it is possible to improve the alignment of the liquid crystal molecules and to prevent the alignment of the liquid crystal molecules from being deteriorated with the passage of time.

According to yet still another aspect of the invention, a liquid crystal panel includes the above-mentioned electronic device substrate; and a liquid crystal layer which is provided on a surface of the substrate opposite to the alignment film.

In this way, it is possible to obtain a liquid crystal panel having high reliability.

According to still yet another aspect of the invention, a liquid crystal panel includes a pair of the electronic device substrates; and a liquid crystal layer which is interposed between the alignment films of the pair of electronic device substrates.

In this way, it is possible to obtain a liquid crystal panel having high reliability.

According to yet still another aspect of the invention, an electronic apparatus includes the above-mentioned liquid crystal panel.

In this way, it is possible to obtain an electronic apparatus having high reliability.

### BRIEF DESCRIPTION OF THE DRAWINGS

The drawings described herein are for illustration purposes only and are not intended to limit the scope of the present disclosure in any way.

FIG. 1 is a longitudinal cross-sectional view schematically illustrating a first embodiment of a liquid crystal panel of the invention;

FIG. 2 is a longitudinal cross-sectional view schematically illustrating the structure of an alignment film provided in the liquid crystal panel shown in FIG. 1;

FIG. 3 is a diagram schematically illustrating the structure of a processing apparatus used for a method of manufacturing an electronic device substrate of the invention;

FIG. 4 is a longitudinal cross-sectional view schematically illustrating a second embodiment of the liquid crystal panel of the invention;

FIG. 5 is a perspective view illustrating the structure of a portable personal computer (or a notebook computer), which is an example of an electronic apparatus according to the invention;

FIG. 6 is a perspective view illustrating the structure of a cellular phone (including PHS), which is an example of the electronic apparatus according to the invention;

FIG. 7 is a perspective view illustrating the structure of a digital still camera, which is an example of the electronic apparatus according to the invention; and

FIG. 8 is a diagram schematically illustrating an optical system of a projection display apparatus, which is an example of the electronic apparatus according to the invention;

### DETAILED DESCRIPTION OF THE PREFERRED EMBODIMENTS

The following description is merely exemplary in nature and is not intended to limit the present disclosure, application, or uses. It should be understood that throughout the drawings, corresponding reference numerals indicate like or corresponding parts and features.

Hereinafter, a method of processing an inorganic oxide film, an electronic device substrate, a method of manufacturing an electronic device substrate, a liquid crystal panel, and an electronic apparatus according to the invention will be described below with reference to the accompanying drawings.

First, the liquid crystal panel according to the invention will be described below.

### FIRST EMBODIMENT

A first embodiment of the liquid crystal panel according to the invention will be described below.

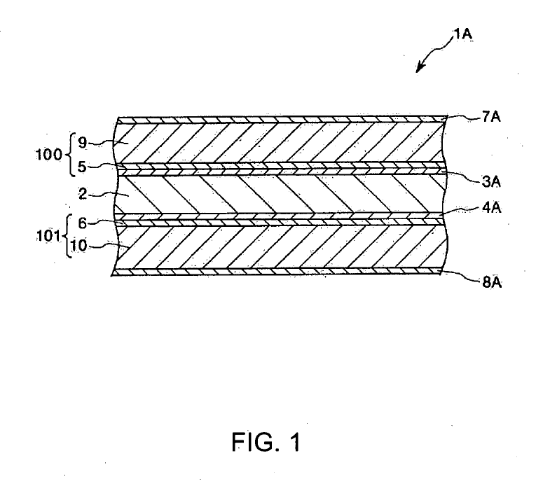

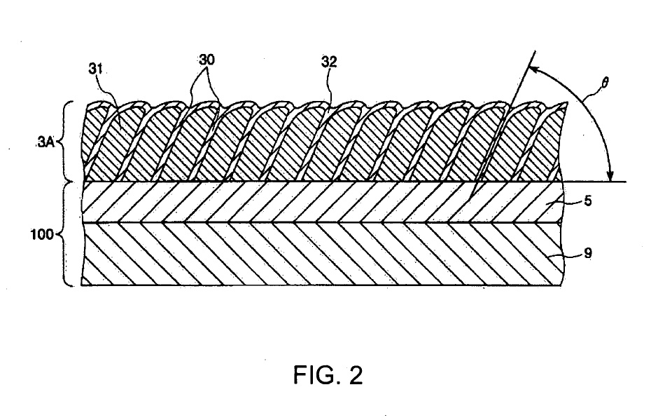

FIG. 1 is a longitudinal cross-sectional view schematically illustrating the first embodiment of the liquid crystal panel according to the invention. FIG. 2 is a longitudinal cross-sectional view schematically illustrating the structure of an alignment film included in the liquid crystal panel shown in FIG. 1. In FIG. 1, for example, a sealing material and wiring lines are not shown. In addition, in the following description, upper parts of FIGS. 1 and 2 are referred to as upper sides, and lower parts thereof are referred to as lower sides.

A liquid crystal panel 1A shown in FIG. 1 includes a liquid crystal layer 2, alignment films 3A and 4A, transparent conductive films 5 and 6, polarizing films 7A and 8A, and substrates 9 and 10.

In this structure, the substrate 9, the transparent conductive film 5 (electrode), and the alignment film 3A form an electronic device substrate of the invention, and the substrate 10, transparent conductive film 6 (electrode), and the alignment film 4A form another electronic device substrate of the invention.

In the structure shown in FIG. 1, neither the transparent conductive film 5 nor the transparent conductive film 6 is divided. However, in general, at least one of the films is divided into individual electrodes (pixel electrodes).

The liquid crystal layer 2 contains liquid crystal molecules (liquid crystal material).

For example, any of the following materials may be used as the liquid crystal molecules: a phenylcyclohexane derivative, a biphenyl derivative, a biphenylcycloxehane derivative, a terphenyl derivative, a phenyl ether derivative, a phenyl ester derivative, a bicyclohexane derivative, an azomethine derivative, an azoxy derivative, a pyrimidine derivative, a dioxane derivative, a cubane derivative, and materials obtained by introducing fluorine-based substituents, such as a fluoro group, a trifluoromethyl group, a trifluoromethoxy group, or a difluoromethoxy group, into these derivatives.

As will be described later, when the alignment films 3A and 4A are used, it is easy to vertically align the liquid crystal molecules. For example, compounds represented by the following chemical formulas 1 to 3 are used as the liquid crystal molecules suitable for vertical alignment: 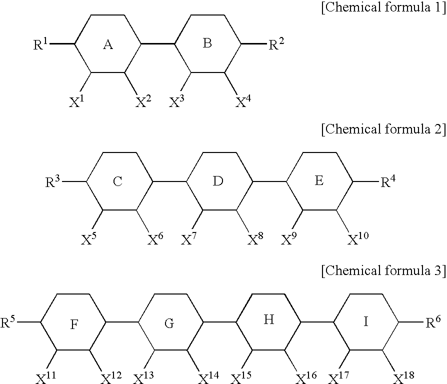
(wherein rings A to I indicate cyclohexane rings or benzene rings, R¹ to R⁶ indicate any one of an alkyl group, an alkoxy group, and a fluorine atom, and X¹ to X¹⁰ indicate hydrogen atoms or fluorine atoms).

The alignment films 3A and 4A are arranged on both surfaces of the liquid crystal layer 2.

The alignment film 3A is formed on a base member 100 composed of the transparent conductive film 5 and the substrate 9, and the alignment film 4A is formed on a base member 101 composed of the transparent conductive film 6 and the substrate 10.

The alignment films (vertical alignment films) 3A and 4A have a function of controlling the alignment state of the liquid crystal molecules constituting the liquid crystal layer 2 (when no voltage is applied).

In addition, since the alignment films 3A and 4A have the same structure, only the alignment film 3A will be described as a representative example.

As shown in FIG. 2, the alignment film 3A is composed of an inorganic oxide film 31 formed by an oblique deposition method and a film 32 formed on the inorganic oxide film 31 by a method, which will be described later.

As shown in FIG. 2, since the inorganic oxide film 31 is formed by the oblique deposition method, it has a plurality of pores 30 therein, and each of the pores 30 is uniaxially arranged such that its axis is inclined with respect to an upper surface of the base member 100 (a surface having the alignment film 3A formed thereon).

In this structure, that the axis of each of the pores 30 is uniaxially arranged means that almost all the pores 30 are inclined in the same direction (the average directions of the pores 30 are controlled). Some of the pores 30 may be inclined in a direction different from the direction in which the other pores 30 are inclined.

The pores 30 regularly arranged cause the inorganic oxide film 31 (the alignment film 3A) to have high regularity in structure.

This structure makes it easy for the liquid crystal molecules contained in the liquid crystal layer 2 to be vertically aligned (homeotropic alignment). Therefore, the alignment film 3A having this structure is useful for a VA (vertical alignment) liquid crystal panel.

Since the alignment film 3A has high regularity in its structure, the liquid crystal molecules are accurately arranged in a fixed direction (vertical direction), which results in an improvement in the performance (characteristic) of the liquid crystal panel 1A.

Further, an angle (an angle θ in FIG. 2) formed between the pores 30 and the upper surface of the base member 100 is preferably in the range of 30° to 70°, more preferably, in the range of 40° to 60°. However, the angle is not limited to the above-mentioned angular range. In this way, it is possible to reliably arrange the liquid crystal molecules in the vertical direction.

The inorganic oxide film 31 is a film having an inorganic oxide as a main ingredient. In general, an inorganic material has higher chemical stability (optical stability) than an organic material. Therefore, the inorganic oxide film 31 (the alignment film 3A) has higher light resistance than an alignment film formed of an organic material.

It is also preferable that the inorganic oxide forming the inorganic oxide film 31 have a relatively small dielectric constant, which makes it possible to effectively prevent the irregularity of images displayed on the liquid crystal panel 1A.

For example, any of the following materials may be used as the inorganic oxide: silicon oxides, such as SiO₂ and SiO, metallic oxides, such as Al₂O₃, MgO, TiO, TiO₂, In₂O₃, Sb₂O₃, Ta₂O₅, Y₂O₃, CeO₂, WO₃, CrO₃, GaO₃, HfO₂, Ti₃O₅, NiO, ZnO, Nb₂O₅, ZrO₂, and Ta₂O₅, and combinations of two or more materials of these. In particular, it is preferable to use, as the inorganic oxide, a material having SiO₂ as a main ingredient because SiO₂ has a small dielectric constant and high optical stability.

The film 32 is formed on the surface of the inorganic oxide film 31 and the inner surfaces of the pores 30.

The film 32 is formed by treating the inorganic oxide film 31 with a treatment liquid, which will be described later. That is, the film 32 is formed by chemically reacting (esterifying) an active hydroxyl group existing in the surface of the inorganic oxide film 31 and the inner surfaces of the pores 30 with a hydroxyl group having alcohol, and is mainly formed of a main skeletal portion of alcohol.

This embodiment is characterized in that a plurality of kinds of alcohol having different molecular weights are used.

For example, when a material containing two types of alcohol, that is, a primary alcohol and a secondary alcohol having a lower molecular weight than that of the primary alcohol, is used, the following effects are obtained.

Firstly, the secondary alcohol having a relatively low molecular weight may be deeply infiltrated into the pores 30 of the inorganic oxide film 31 to be chemically bonded thereto. In this way, it is possible to reduce the number of active hydroxyl groups existing on the inner surfaces of the pores 30.

Secondly, the primary alcohol having a relative high molecular weight may be chemically bonded to the inorganic oxide film 31, with hydrocarbon, which is a main skeletal portion, facing the liquid crystal layer 2 in the surface of the inorganic oxide film 31. Since the portion has a relatively strong affinity with respect to the liquid crystal molecules, strong anchoring force is obtained with respect to the liquid crystal molecules.

Third, since the primary alcohol having a relatively high molecular weight has a large main skeletal portion, it is chemically bonded sparsely in the vicinity of the surface of the inorganic oxide film 31 due to the steric hindrance of the portion, and the second alcohol is chemically bonded to the hydroxyl group between the primary alcohol molecules, which makes it possible to reliably reduce the number of active hydroxyl groups existing in the inorganic oxide film 31.

In this way, it is possible to reliably arrange the liquid crystal molecules in the vertical direction in the liquid crystal panel 1A using the electronic device substrate of the invention. In addition, it is possible to prevent various impurities from being stuck on the inorganic oxide film 31 due to the existence of the active hydroxyl groups, and the inorganic oxide film 31 from reacting with the liquid crystal molecules. As a result, for example, it is possible to prevent vertical anchoring force with respect to the liquid crystal molecules of the alignment film 3A from being lowered and thus to prevent the liquid crystal molecules from being abnormally aligned.

That is, according to this embodiment of the invention, since a plurality of kinds of alcohol having different molecular weights may be used to treat the inorganic oxide film 31, it is possible to improve both the characteristics and the light resistance (durability) of the liquid crystal panel 1A by the synergistic effect of the plurality of kinds of alcohol.

The primary alcohol preferably has 5 to 30 carbon atoms, more preferably, 8 to 30 carbon atoms. Even when the alcohol is in a liquid state or a semisolid state (solid state) at room temperature, it can turn to a liquid state at a relatively low temperature. Therefore, when the inorganic oxide film 31 is treated with a treatment liquid, which will be described later, it is possible to easily treat the inorganic oxide film 31.

Since the alcohol having the carbon atoms has a strong affinity for the liquid crystal molecules, it is possible to reliably strengthen the vertical anchoring force with respect to the liquid crystal molecules.

In addition, any of the following materials may be used as the primary alcohol: an aliphatic alcohol, an aromatic alcohol, an alicyclic alcohol, a heterocyclic alcohol, a polyvalent alcohol, and halogen-substituted products thereof (in particular, fluorine-substituted products). Among them, the aromatic alcohol, the alicyclic alcohol, or the fluorine-substituted product thereof (fluoroalcohol) is preferable. The use of the aromatic alcohol, the alicyclic alcohol, or the fluorine-substituted product thereof makes it possible to strengthen vertical anchoring force with respect to the liquid crystal molecules and reliably arrange the liquid crystal molecules in the vertical direction.

It is preferable that the alicyclic alcohol or the fluorine-substituted product thereof have a steroid skeleton. Since the alicyclic alcohol or the fluorine-substituted product thereof with a steroid skeleton has a high degree of flatness, it is most suitable for controlling the alignment of the liquid crystal molecules.

Any of the following materials may be used as the primary alcohol in consideration of the above-mentioned factors: aliphatic alcohols, such as octanol, nonanol, decanol, undecanol, dodecanol, tridecanol, tetradecanol, pentadecanol, hexadecanol, heptadecanol, octadecanol, eicosanol, heneicosanol, docosanol, tricosanol, and tetracosanol; alicyclic alcohols, such as cholesterol, epicholesterol, cholestanol, epicholestanol, ergostanol, epiergostanol, coprostanol, epicoprostanol, α-ergosterol, β-sitosterol, stigmasterol, and campesterol, and fluorine-substituted products thereof.

Further, preferably, in the aliphatic alcohol or the fluorine-substituted products thereof, hydrocarbon or carbon fluoride (a main skeletal portion) may be in the shape of a straight chain or a branch.

For example, in addition to the above-mentioned materials, any of the following materials can be used as the primary alcohol: aliphatic alcohols, such as hexanol, heptanol, and triacontanol; alicyclic alcohols, such as cycloxanol, 4-methyl-cyclohexanol, and cycloheptanol; aromatic alcohols, such as phenol, benzylalcohol, and p-chlorbezylalcohol; heterocyclic alcohols, such as furfurylalcohol; multivalent alcohols, such as ethyleneglycol and glycerine; and fluorine-substituted products thereof.

Meanwhile, the secondary alcohol preferably has 1 to 4 carbon atoms, more preferably, 1 to 3 carbon atoms. Since the primary alcohol having the carbon atoms has a small molecular size, it can be deeply permeated into the pores.

Further, any of an aliphatic alcohol, a polyvalent alcohol, and halogen-substituted products thereof (in particular, fluorine-substituted products) is used as the secondary alcohol. Among them, the aliphatic alcohol or the fluorine-substituted product thereof (fluoroalcohol) is preferable. Since the aliphatic alcohol or the fluorine-substituted product thereof has a molecular structure close to a straight line, it can be deeply infiltrated into the pores 30.

Methanol, ethanol, propyl alcohol, or the fluorine-substituted product thereof may be used for the secondary alcohol.

In addition to the above-mentioned materials, for example, any of polyvalent alcohols, such as ethylene glycol and glycerin, and the fluorine-substituted products thereof can be used as the secondary alcohol.

Since a large number of liquid crystal molecules are fluoridized, the used of the fluorine-substituted products makes it possible to improve an affinity for the liquid crystal molecules and thus to reliably arrange the liquid crystal molecules in the vertical direction.

When the primary alcohol is represented by a character A and the secondary alcohol is represented by a character B, A minus B is preferably equal to or larger than 3, more preferably, equal to or larger than 5. A combination of two kinds of alcohols satisfying the carbon atom relationship makes it possible to improve both the characteristics and the light resistance (durability) of the liquid crystal panel 1A.

In this case, the mole ratio of the primary alcohol to the second alcohol, which are chemically bonded to each other in the vicinity of the surface of the inorganic oxide film 31, is preferably in the range of 50:50 to 95:5, more preferably, 60:40 to 90:10. In this way, it is possible to obtain remarkable effects of reliably arranging the liquid crystal molecules in the vertical direction and of preventing the alignment disorder of the liquid crystal molecules due to a time variation.

It is possible to adjust the ratio of the primary alcohol to the secondary alcohol chemically bonded to the primary alcohol by appropriately setting, for example, a compound ratio of the primary alcohol to the secondary alcohol in a treatment liquid used for a first manufacturing method, which will be described later, the kind or molecular weight of the primary alcohol and the secondary alcohol, and conditions when alcohol is chemically bonded to the inorganic oxide film 31.

The alignment film 3A has an average thickness of about 20 to 300 nm, preferably, about 20 to 150 nm, and more preferably, 20 to 80 nm, but the average thickness is not limited to the above-mentioned values. When the thickness of the alignment film 3A is excessively small, the liquid crystal molecules come into direct contact with the transparent conductive films 5 and 6, which makes it difficult to prevent the contact therebetween. On the other hand, when the thickness of the alignment film 3A is excessively large, a high voltage is needed to drive the liquid crystal panel 1A, resulting in an increase in power consumption.

The transparent conductive film 5 is arranged on the outer surface (the upper surface in FIG. 1) of the alignment film 3A. Similarly, the transparent conductive film 6 is arranged on the outer surface (the lower surface in FIG. 1) of the alignment film 4A.

The transparent conductive films 5 and 6 have a function of changing the alignment directions of the liquid crystal molecules contained in the liquid crystal layer 2 by performing charge or discharge therebetween.

The charge or discharge between the transparent conductive films 5 and 6 is controlled by adjusting a current supplied from a control circuit (not shown) connected to the transparent conductive films 5 and 6.

The transparent conductive films 5 and 6 are formed of a conductive material, such as indium tin oxide (ITO), indium oxide (IO), or tin oxide (SnO₂).

The substrate 9 is arranged on the outer surface (the upper surface in FIG. 1) of the transparent conductive film 5. Similarly, the substrate 10 is arranged on the outer surface (the lower surface in FIG. 1) of the transparent conductive film 6.

The substrates 9 and 10 have functions of supporting the liquid crystal layer 2, the alignment films 3A and 4A, the transparent conductive films 5 and 6, and the polarizing films 7A and 8A, which will be described later.

The substrates 9 and 10 are formed of various glass materials, such as quartz glass, and various plastic materials, such as polyethylene terephthalate. Among these materials, particularly, it is preferable that the substrates 9 and 10 be formed of various glass materials. In this way, it is possible to prevent the liquid crystal panel 1A from being warped or bent and thus improve the stability of the liquid crystal panel 1A.

The polarizing film (a polarizing plate) 7A is arranged on the outer surface (the upper surface in FIG. 1) of the substrate 9. Similarly, the polarizing film (a polarizing plate) 8A is arranged on the outer surface (the lower surface in FIG. 1) of the substrate 10.

The polarizing films 7A and 8A are formed of, for example, a polyvinyl alcohol (PVA). In addition, the polarizing films may be formed of a material obtained by doping iodine into the above-mentioned material.

For example, the polarizing films may be formed by uniaxially extending a film made of the above-mentioned material.

The polarizing films 7A and 8A makes it possible to adjust the passage of current and thus to reliably control the transmittance of light.

The directions of polarizing axes of the polarizing films 7A and 8A depend on the alignment directions of the alignment films 3A and 4A (in this embodiment, when a voltage is applied).

Next, a description will be made of a method of manufacturing the electronic device substrate used for the method of treating the inorganic oxide film according to the invention.

First Manufacturing Method

First, a first embodiment of the method of manufacturing the electronic device substrate according to the invention (a first manufacturing method) will be described below.

The first manufacturing method of the electronic device substrate includes a process 1A of forming an inorganic oxide film, a process 2A of dipping the inorganic oxide film into a treatment liquid S, a process 3A of infiltrating a treatment liquid S into the inorganic oxide film, and a process 4A of reacting with alcohol.

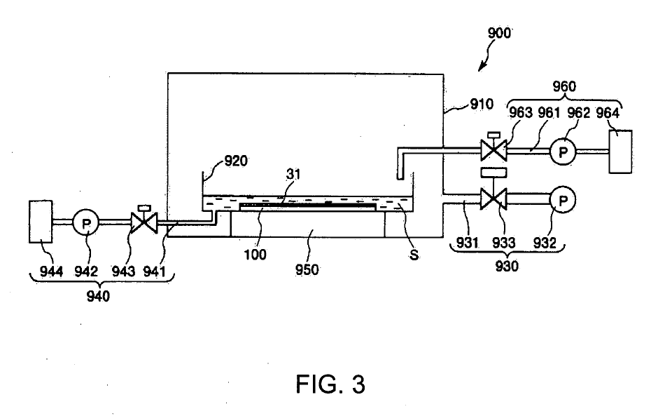

A processing apparatuses 900 shown in FIG. 3 is used in the processes 2A to 4A and the subsequent processes 4B and 6B.

The processing apparatus 900 shown in FIG. 3 includes a chamber 910, a stage 950 provided in the chamber 910, a vessel 920 arranged on the stage 950, a liquid supply unit 960 for supplying the treatment liquid S into the vessel 920, a liquid discharging unit 940 for discharging the treatment liquid S from the vessel 920, and an air exhausting unit 930 for exhausting air from the chamber 910.

For example, a heating unit (not shown), such as a heater, is provided on the stage 950.

The air exhausting unit 930 includes a pump 932, an exhaust line 931 connecting the pump 932 and the chamber 910, and a valve 933 provided in the middle of the exhaust line 931.

The liquid discharging unit 940 includes a recovery tank 944 for collecting the treatment liquid S, a liquid discharge line 941 for connecting the recovery tank 944 and the vessel 920, and a pump 942 and a valve 943 provided in the middle of the liquid discharge line 941.

The liquid supply unit 960 includes a storage tank 964 having the treatment liquid S stored therein, a liquid supply line 961 for guiding the treatment liquid S from the storage tank 964 to the vessel 920, a pump 962 and a value 963 provided in the middle of the liquid supply line 961.

Heading units (not shown), such as heaters, are provided in the liquid discharging unit 940 and the liquid supply unit 960 to heat the treatment liquid S.

Next, the above-mentioned processes will be sequentially described below.

1A: Process of Forming Inorganic Oxide Film

First, the inorganic oxide film 31 is formed on the base member 100 (a surface of the substrate 9) by an oblique deposition method. The inorganic oxide film 31 having a plurality of pores 30 is obtained by the oblique deposition method.

In this case, it is possible to adjust an angle formed between the pores 30 and the upper surface of the base member 100 by appropriately setting an angle where an inorganic oxide vaporized from a vapor source reaches the upper surface of the base member 100.

It is preferable that the base member 100 be separated from the vapor source as far as possible. A sufficient separation distance between the base member 100 and the vapor source causes the inorganic oxide vaporized from the vapor source to reach the base member 100 substantially in the same direction. In this way, the inorganic oxide film 31 having a high degree of alignment is obtained.

2A: Process of Dipping Inorganic Oxide Film into Treatment Liquid S

Then, the base member 100 having the inorganic oxide film 31 formed thereon is dipped into the treatment liquid S containing the primary alcohol and the secondary alcohol.

More specifically, the chamber 910 is opened, and the base member 100 having the inorganic oxide film 31 formed thereon is carried into the chamber to be arranged in the vessel 920.

Subsequently, the chamber 910 is closed and the pump 962 is operated. In this state, the valve 963 is opened to cause the treatment liquid S to be supplied from the storage tank 964 to the vessel 920 through the liquid supply line 961.

When a predetermined amount of treatment liquid S, that is, a sufficient amount of treatment liquid S to completely immerse the base member 100, is supplied into the vessel 920, the pump 962 stops and the valve 963 is closed.

In this case, alcohol may be in a liquid, solid, or semisolid state at room temperature.

When alcohol that is in a liquid state at room temperature is used, the alcohol (substantially 100% alcohol) can be used for the treatment liquid S, or a material obtained by mixing alcohol with a proper solvent can be used for the alcohol.

When the alcohol that is in a solid or semisolid state at room temperature is used, the solid or semisolid alcohol can be heated to be used for the treatment liquid S, or a material obtained by mixing alcohol with a proper solvent can be used for the alcohol.

When alcohol is mixed with a solvent or is dissolved thereinto, a solvent capable of being mixed with alcohol or dissolving the alcohol and having lower polarity than that of alcohol is selected. In this way, it is possible to prevent a solvent from hindering the reaction between alcohol and the hydroxyl group of the inorganic oxide film 31 in the subsequent process 4A, and thus to reliably generate a chemical reaction.

When the alcohol containing the primary alcohol and the secondary alcohol is used, the compound ratio of the primary alcohol to the secondary alcohol is preferably in the range of 70:30 to 90:10, more preferably, 75:25 to 85:15. This range of the compound ratio enables the primary alcohol to be deeply permeated into the pores 30, resulting in a reliable chemical bond therebetween. In addition, this structure makes it possible to reliably adjust the ratio of the primary alcohol to the secondary alcohol within the above-mentioned range in the vicinity of the surface of the inorganic oxide film 31.

3A: Process of Infiltrating Treatment Liquid S into Inorganic Oxide Film

Next, pressure in the chamber 910 (a space where the treatment liquid S is placed) is reduced to infiltrate the treatment liquid S into the pores 30 of the inorganic oxide film 31.

More specifically, the chamber 910 is closed and the pump 932 is operated. In this state, the valve 933 is opened to cause gas to be exhausted from the chamber 910 to the outside of the processing apparatus 900 through the exhaust line 931.

When the pressure in the chamber 910 is gradually reduced, vapor (for example, air) is removed from the treatment liquid S and the pores 30 of the inorganic oxide film 31, and the treatment liquid S is permeated into the pores 30.

When the pressure in the chamber 910 reaches a predetermined value, the pump 932 stops, and the valve 933 is closed.

The pressure in the chamber 910 (the space), that is, a degree of vacuum in the chamber 910 is preferably in the range of about 1×10⁻⁴ to 1×10⁴ Pa, more preferably, about 1×10⁻² to 1×10³ Pa. In this way, air is sufficiently removed from the pores 30 of the inorganic oxide film 31, which makes it possible to infiltrate a sufficient amount of treatment liquid S into the pores 30.

Then, the pump 942 is operated. In this state, the valve 943 is opened to cause the remaining treatment liquid S in the chamber 920 to be collected to the recovery tank 944 through the liquid discharge line 941.

Subsequently, when almost the entire treatment liquid S is collected from the vessel 920, the pump 942 stops, and the valve 943 is closed.

4A: Process of Reacting with Alcohol

Next, alcohol is chemically bonded (ester bond) to the surface of the inorganic oxide film 31 and the inner surfaces of the pores 30.

More specifically, the heating unit provided on the stage 950 is operated to heat the base member 100 having the inorganic oxide film 31 formed thereon.

In this way, an esterification reaction occurs between the hydroxyl group existing in the surface of the inorganic oxide film 31 and the inner surfaces of the pores 30 and the hydroxyl group included in alcohol to cause the alcohol to be chemically bonded to the surface of the inorganic oxide film 31 and the inner surfaces of the pores 30.

As a result, the film 32 having a main skeletal portion of alcohol as a main component is formed along the surface of the inorganic oxide film 31 and the inner surfaces of the pores 30, so that the alignment film 3A is formed.

Before the heating is performed, pressure in the chamber 910 may be reduced again, if necessary.

The base member 100 is heated at a temperature of about 80° C. to 250° C., preferably, about 100 to 200° C. However, the heating temperature is not limited to the above-mentioned temperature. When the heating temperature is low, a sufficient chemical bond between the inorganic oxide film 31 and alcohol may not occur according to the kind of alcohol or the kind of an inorganic oxide film. When the heating temperature is raised higher than the upper limit, the effect is not improved corresponding to the increase in the heating temperature.

Further, the substrate 100 is preferably heated for about 20 to 180 minutes, and more preferably, for about 40 to 100 minutes. However, the heating time of the substrate 100 is not limited thereto. When the heating time is excessively long, there is a fear that a sufficient amount of alcohol may not be chemically bonded to the inorganic oxide film 31 due to conditions other than the heating temperature. Meanwhile, when the heating time is longer than the upper limit, the effect is not improved corresponding to the increase in the heating time.

As described above, heating is used to react the hydroxyl group existing in the surface of the inorganic oxide film 31 and the inner surfaces of the pores 30 with alcohol, which makes it possible to easily and reliably perform the reaction.

The reaction can occur by, for example, radiation of ultraviolet rays or radiation of infrared rays, in addition to the heating. In this case, mechanisms (units) required for performing the processes are provided in the processing apparatus 900.

In the first manufacturing method, since the treatment liquid S contains the primary alcohol and the secondary alcohol, it is preferable that the primary alcohol and the secondary alcohol have high compatibility. More specifically, it is preferable that aliphatic alcohol or the fluorine-substituted product thereof be used for both the primary alcohol and the secondary alcohol.

Second Manufacturing Method

Next, a second embodiment of the method of manufacturing the electronic device substrate according to the invention (a second manufacturing method) will be described below.

Hereinafter, the second manufacturing method will be described, centered on a difference from the first manufacturing method. In the second manufacturing method, a description of the same matters as those in the first manufacturing method will be omitted.

The second manufacturing method of the electronic device substrate includes a process 1B of forming an inorganic oxide film, a process 2B of bringing the inorganic oxide film into contact with a first treatment liquid S1, a process 3B of reacting with alcohol, a process 4B of dipping the inorganic oxide film into a second treatment liquid S2, a process 5B of infiltrating the second treatment liquid S2 into the inorganic oxide film, and a process 6B of reacting with alcohol.

Next, the processes will be sequentially described below.

1B: Process of Forming Inorganic Oxide Film

The process 1B is performed under the same conditions as those in the process 1A.

2B: Process of Bringing First Treatment Liquid S1 into Contact with Inorganic Oxide Film

Next, the first treatment liquid S1 containing the primary alcohol comes into contact with the inorganic oxide film 31 under atmospheric pressure.

Examples of a method of bringing the first treatment liquid S1 into contact with the inorganic oxide film 31 include, for example, a method of applying the first treatment liquid S1 onto the inorganic oxide film 31 (an applying method), a method of dipping the base member 100 having the inorganic oxide film 31 formed thereon into the first treatment liquid S1 (a deposition method), and a method of exposing the inorganic oxide film 31 to vapor of the first treatment liquid S1. In addition, a combination of the methods can be used.

For example, as the applying method, any of the following methods can be used: a spin coating method, a casting method, a micro gravure coating method, a gravure coating method, a bar coating method, a roller coating method, a wire bar coating method, a dip coating method, a spray coating method, a screen printing method, a flexographic printing method, an offset printing method, and an inkjet printing method.

The above-mentioned treatment liquid S can be used as the first treatment liquid S1.

3B: Process of Reacting with Alcohol

The process 3B is performed under the same conditions as those in the process 4A.

4B: Process of Dipping Inorganic Oxide Film into Second Treatment Liquid S2

The process 4B is performed under the same conditions as those in the process 2A.

The above-mentioned treatment liquid S can be used as the second treatment liquid S2. The concentration of alcohol in the second treatment liquid S2 is preferably not less than 70 vol %, and more preferably, not less than 85 vol %.

5B: Process of Infiltrating Second Treatment Liquid S2 into Inorganic Oxide Film

The process 5B is performed under the same conditions as those in the process 3A.

6B: Process of Reacting with Alcohol

The process 6B is performed under the same conditions as those in the process 4A.

The second manufacturing method obtains the same effects as those obtained from the first manufacturing method.

According to the second manufacturing method, the first treatment liquid S1 and the second treatment liquid S2 are independently used to treat the inorganic oxide film 31. It is possible, therefore, to select the kind of the primary and secondary alcohols used, without considering, for example, the compatibility of the primary and secondary alcohols. That is, the second manufacturing method offers a huge selection of the primary and secondary alcohols.

In this case, it is preferable that the first treatment liquid S1 contain a tertiary alcohol having a larger molecular weight than that of the secondary alcohol and different from the primary alcohol and the secondary alcohol in type.

More specifically, it is preferable that an aliphatic alcohol or the fluorine-substituted product thereof be used as the primary alcohol and a combination of an alicyclic alcohol having 5 to 30 carbon atoms (preferably, 8 to 30 carbon atoms) and the fluorine-substituted product thereof be used as the tertiary alcohol. In this way, the tertiary alcohol makes it possible to improve the alignment stability of the primary alcohol.

In the second manufacturing method, the process using the first treatment liquid S1 and the process using the second treatment liquid S2 may be reversely performed.

The method of forming the alignment film 3A has been described above. The above is similarly applied to a method of forming the alignment film 4A.

### SECOND EMBODIMENT

Next, a second embodiment of the liquid crystal panel according to the invention will be described below.

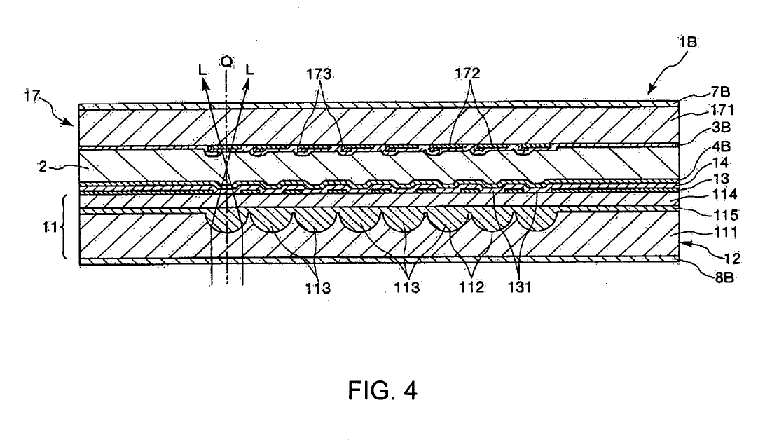

FIG. 4 is a longitudinal cross-sectional view schematically illustrating the second embodiment of the liquid crystal panel according to the invention. In FIG. 4, for example, a sealing material and wiring lines are not shown. In addition, in the following description, an upper part of FIG. 4 is referred to as an upper side, and a lower part thereof is referred to as a lower side.

Hereinafter, the second embodiment will be described, centered on a difference from the first embodiment. In the second embodiment, a description of the same matters as those in the first embodiment will be omitted.

A liquid crystal panel (a TFT liquid crystal panel) 1B shown in FIG. 4 includes a TFT substrate (a liquid crystal driving substrate) 17, an alignment film 3B bonded to the TFT substrate 17, a liquid crystal panel counter substrate 12, an alignment film 4B bonded to the liquid crystal panel counter substrate 12, a liquid crystal layer 2 containing liquid crystal molecules injected into a space between the alignment film 3B and the alignment film 4B, a polarizing film 7B bonded to an outer surface (an upper surface) of the TFT substrate (the liquid crystal driving substrate) 17, and a polarizing film 8B bonded to an outer surface (a lower surface) of the liquid crystal panel counter substrate 12.

In this structure, the TFT substrate 17 and the alignment film 3B form an electronic device substrate of the invention, and the liquid crystal panel counter substrate 12 and the alignment film 4B form another electronic device substrate of the invention.

The alignment films 3B and 4B have the same structures as those of the alignment films 3A and 4A in the first embodiment, and the polarizing films 7B and 8B have the same structures as those of the polarizing films 7A and 8A in the first embodiment.

The liquid crystal panel counter substrate 12 includes a microlens substrate 11, a black matrix 13 which is provided on an outer layer 114 of the microlens substrate 11 and has openings 131 formed therein, and a transparent conductive film (a common electrode) 14 provided on the outer surface 114 so as to cover the black matrix 13.

The microlens substrate 11 includes a substrate 111 having a plurality (a large number) of concave portions (concave portions for microlenses) 112 each having a concave curved surface, a resin layer (an adhesive layer) 115 formed on a surface of the substrate 111 having the concave portions 112 for microlenses provided therein, and the outer layer 114 formed on the resin layer 115.

In the resin layer 115, resin is filled into the concave portions 112 to form microlenses 113.

The substrate 111 having the concave portions for microlenses provided therein is manufactured by a flat mother member (a transparent substrate), and a plurality (a large number) of concave portions 112 are formed in the surface of the substrate 111.

The concave portions 112 can be formed by, for example, a dry etching method or a wet etching method using a mask.

The substrate 111 having the concave portions for microlenses provided therein is formed of, for example, glass.

It is preferable that the linear expansion coefficient of the mother member be substantially equal to that of a glass substrate 171 (for example, the ratio of the heat expansion coefficient of the mother member to the heat expansion coefficient of the glass substrate 117 is in the range of about 1:10 to 10:1). This structure makes it possible to prevent the wrapping, bending, or peeling-off of the two members due to a difference between the heat expansion coefficients of them caused by a variation in temperature in the liquid crystal panel 1B.

From this point of view, it is preferable that the glass substrate 171 and the substrate 111 having the concave portions for microlenses provided therein be formed of the same material. In this case, it is possible to effectively prevent the wrapping, bending, or peeling-off of the two members due to the difference between the heat expansion coefficients of them caused by a variation in temperature.

In particular, when the microlens substrate 11 is used for a TFT liquid crystal panel formed of high-temperature polysilicon, preferably, the substrate 111 having the concave portions for microlenses provided therein is formed of quartz glass. The TFT liquid crystal panel has a TFT substrate as a liquid crystal driving substrate. The TFT substrate is preferably formed of quartz glass whose characteristics are not easily changed under the manufacturing conditions. Therefore, when the substrate 111 having the concave portions for microlenses provided therein is formed of quartz glass, it is possible to effectively prevent the wrapping, bending, or peeling-off of the members and thus obtain the TFT liquid crystal panel 1B having high stability.

The resin layer (the adhesive layer) 115 is provided on the upper surface of the substrate 111 so as to cover the concave portions 112 for microlenses.

A material forming the resin layer 115 is filled into the concave portions 112 to form the microlenses 113.

The resin layer 115 can be formed of, for example, resin (adhesive) having a refractive index higher than that of a material forming the substrate 111 having the concave portions for microlenses provided therein. For example, the resin layer 115 can be formed of an ultraviolet-curable resin, such as an acryl-based resin, an epoxy-based resin or an acryl-epoxy-based resin.

The flat outer layer 114 is formed on the upper surface of the resin layer 115.

The outer layer (glass layer) 114 can be formed of, for example, glass. In this case, it is preferable that the heat expansion coefficient of the outer layer 114 be substantially equal to that of the substrate 111 having the concave portions for microlenses provided therein (for example, the ratio of the heat expansion coefficient of the outer layer 114 to the heat expansion coefficient of the substrate 111 is in the range of about 1:10 to 10:1). This structure makes it possible to prevent the wrapping, bending, or peeling-off of the outer layer 114 and the substrate 111 due to a difference between the heat expansion coefficients of these materials. When the outer layer 114 and the substrate 111 having the concave portions for microlenses provided therein are formed of the same material, the above-mentioned effects can be more effectively obtained.

When the microlens substrate 11 is used for a liquid crystal panel, in order to provide the necessary optical characteristics, the average thickness of the outer layer 114 is preferably in the range of about 5 to 1000 μm, and more preferably, in the range of about 10 to 150 μm.

The outer layer (barrier layer) 114 can be formed of, for example, ceramics. For example, as the ceramics, any of the following materials can be used: nitride-based ceramics, such as AlN, SiN, TiN, and BN, oxide-based ceramics, such as Al₂O₃ and TiO₂, and carbide-based ceramics, such as WC, TiC, ZrC, and TaC.

When the outer layer 114 is formed of ceramics, the average thickness of the outer layer 114 is preferably in the range of 20 nm to 20 μm, and more preferably, in the range of 40 nm to 1 μm. However, the average thickness of the outer layer 114 is not limited to the above-mentioned values.

The outer layer 114 may be omitted, if necessary.

The black matrix 13 has a light shielding property, and is formed of a metallic material, such as Cr, Al, an Al alloy, Ni, Zn, and Ti, or resin having carbon or titanium dispersed therein.

The transparent conductive film 14 has a conductive property and is formed of, for example, indium tin oxide (ITO), indium oxide (IO), or tin oxide (SnO₂).

The TFT substrate 17 is a substrate for driving (controlling the alignment of) the liquid crystal molecules included in the liquid crystal layer 2, and includes a glass substrate 171, a plurality (a large number) of pixel electrodes 172 arranged in a matrix on the glass substrate 171, and a plurality (a large number) of thin film transistors (TFTs) 173 corresponding to the pixel electrodes 172.

It is preferable that the glass substrate 171 be formed of quartz glass for the above-mentioned reason.

A charge or discharge between the pixel electrodes 172 and the transparent conductive film 14 (the common electrode) causes the liquid crystal molecules of the liquid crystal layer 2 to be driven. The pixel electrodes 147 are formed of, for example, the same material as that forming the transparent conductive film 14.

The thin film transistors 173 are connected to the corresponding pixel electrodes 172. The thin film transistors 173 are also connected to a control circuit (not shown) to control a current supplied to the pixel electrodes 172. In this way, the charge or discharge of the pixel electrodes 172 is controlled.

The alignment film 3B is bonded to the pixel electrodes 172 of the TFT substrate 17, and the alignment film 4B is bonded to the transparent conductive film 14 of the liquid crystal panel counter substrate 12.

The liquid crystal layer 2 contains the liquid crystal molecules (liquid crystal material), and the alignment of the liquid crystal molecules is controlled by the charge of discharge of the pixel electrodes 172.

In the liquid crystal panel 1B, generally, one pixel is composed of one microlens 113, one opening 131 of the black matrix 13 corresponding to an optical axis Q of the microlens 113, one pixel electrode 172, and one thin film transistor 173 connected to the pixel electrode 172.

Light L incident from the liquid crystal panel counter substrate 12 passes through the substrate 111 having the concave portions for microlenses formed therein, and is then condensed by the microlens 113. Then, the condensed light sequentially passes through the resin layer 115, the outer layer 114, the opening 131 of the black matrix 13, the transparent conductive film 14, the liquid crystal layer 2, the pixel electrode 172, and the glass substrate 171.

At that time, when the incident light L passes through the liquid crystal layer 2, the polarizing film 8B provided on the light incident side of the microlens substrate 11 causes the incident light L to be linearly polarized.

In this case, the polarized direction of the incident light L is controlled to correspond to the alignment state of the liquid crystal molecules of the liquid crystal layer 2. The incident light L passing through the liquid crystal panel 1B and the polarizing film 7B makes it possible to control the brightness of the emitted light.

The liquid crystal panel 1B has the microlenses 113. The incident light L is condensed by the microlenses 113, and the condensed light passes through the openings 131 of the black matrix 13.

Meanwhile, the incident light L is shielded in portions of the black matrix 13 where the openings 131 are not formed. Therefore, in the liquid crystal panel 1B, it is possible to prevent the leakage of light from portions other than the pixels and thus to prevent the attenuation of the incident light L in the pixels. As a result, the liquid crystal panel 1B has high transmittance in the pixels.

For example, the liquid crystal panel 1B can be manufactured by the following method.

First, the TFT substrate 17 and the liquid crystal panel counter substrate 12 are prepared by a well-known method.

Then, the alignment films 3B and 4B are formed on these substrates by a method of manufacturing an electronic device substrate of the invention, thereby forming electronic device substrates of the invention.

Subsequently, these substrates are bonded to each other by a sealing member (not shown), and liquid crystal is injected into a space formed between the substrates through an injection hole (not shown) formed in the sealing member. Then, the injection hole is sealed.

In the liquid crystal panel 1B, the TFT substrate is used as the liquid crystal driving substrate. However, substrates other than the TFT substrate, such as a TFD substrate and an STN substrate, may be used as the liquid crystal driving substrate.

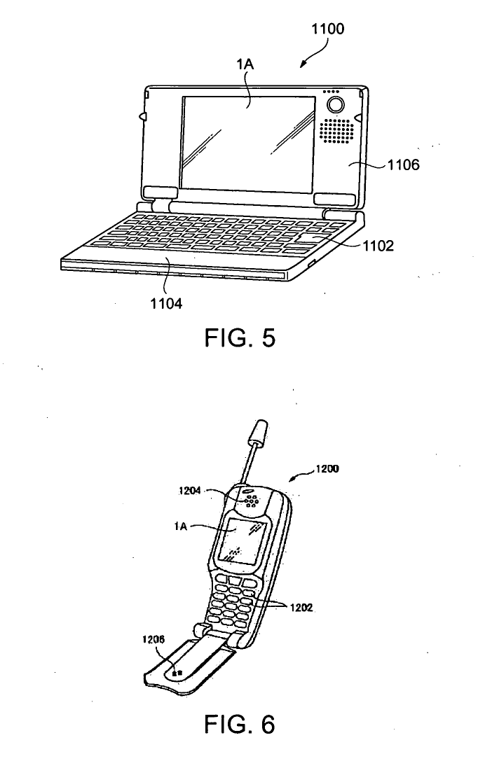

Next, an electronic apparatus (a liquid crystal display device) including the liquid crystal panel 1A according to the invention will be described below in detail with reference to FIGS. 5 to 7.

FIG. 5 is a perspective view illustrating the structure of a portable personal computer (a notebook computer), which is an electronic apparatus to which the invention is applied.

In FIG. 5, a personal computer 1100 includes a main body portion 1104 provided with a keyboard 1102 and a display device unit 1106. The display unit 1106 is rotatably supported by the main body portion 1104 through a hinge structure.

In the personal computer 1100, the display unit 1106 includes the liquid crystal panel 1A and a backlight (not shown). Light emitted from the backlight passes through the liquid crystal panel 1A, thereby displaying images (information).

FIG. 6 is a perspective view illustrating the structure of a cellular phone (including PHS), which is an electronic apparatus to which the invention is applied. In FIG. 6, a cellular phone 1200 includes a plurality of operating buttons 1202, an earpiece 1204, a mouthpiece 1206, the liquid crystal panel 1A, and a backlight (not shown).

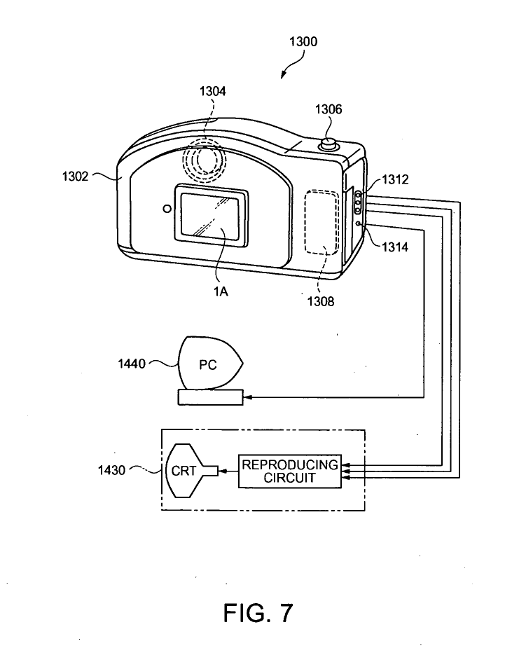

FIG. 7 is a perspective view illustrating the structure of a digital still camera, which is an electronic apparatus to which the invention is applied. FIG. 7 also schematically shows a connection between the digital still camera and an external apparatus.

A general camera exposes a silver photographic film by the light image of a subject. In contrast, a digital still camera 1300 photo-electrically converts the optical image of a subject by an image pick-up device, such as a charge coupled device (CCD), to generate image signals.

The liquid crystal panel 1A and a backlight (not shown) are provided on the rear surface of a case (body) 1302 of the digital still camera 1300. A display operation is performed on the basis of the image signals captured by the CCD. The liquid crystal panel 1A functions as a finder for displaying a subject as an electronic image.

A circuit board 1308 is provided in the case. A memory for storing image signals is provided on the circuit board 1308.

A light-receiving unit 1304 including, for example, an optical lens (an image capturing optical system) or a CCD is provided on the front side of the case 1302 (on the rear side of FIG. 7).

When a photographer recognizes the image of a subject displayed on the liquid crystal panel 1A and pushes a shutter button 1306, the image signal of the CCD at that time is transmitted to the memory of the circuit board 1308 and is then stored therein.

In the digital still camera 1300, a video signal output terminal 1312 and an input/output terminal 1314 for data communication are provided at the side of the case 1302. As shown in FIG. 7, a television monitor 1430 is connected to the video signal output terminal 1312, and a personal computer 1440 is connected to the input/output terminal 1314 for data communication, if necessary. Furthermore, a predetermined operation causes the image signal stored in the memory of the circuit board 1308 to be output to the television monitor 1430 or the personal computer 1440.

Next, a description will be made of an electronic apparatus (a liquid crystal projector) using the liquid crystal panel 1B, which is an example of the electronic apparatus of the invention.

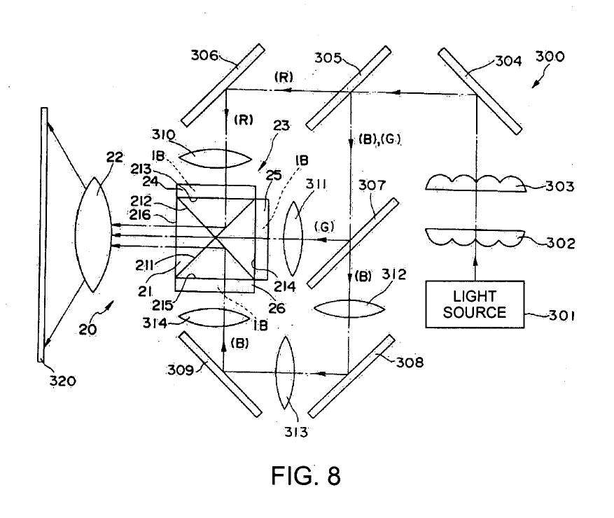

FIG. 8 is a diagram schematically illustrating an optical system of an electronic apparatus (a projection display apparatus) of the invention.

As shown in FIG. 8, a projection display apparatus 300 includes an illumination optical system having a light source 301 and a plurality of integrator lenses, a color separating optical system (a light guide optical system) having, for example, a plurality of dichroic mirrors, a (red) liquid crystal light valve 24 (a liquid crystal light shutter array) corresponding to red, a (green) liquid crystal light valve 25 (a liquid crystal light shutter array) corresponding to green, a (blue) liquid crystal light valve 26 (a liquid crystal light shutter array) corresponding to blue, a dichroic prism (a color combining optical system) 21 composed of a dichroic mirror surface 211 which reflects only a red light component and a dichroic mirror surface 212 which reflects only a blue light component, and a projection lens (a projection optical system) 22.

The illumination optical system includes integrator lenses 302 and 303. The color separating optical system includes, mirrors 304, 306, and 309, a dichroic mirror 305 that reflects blue and green light components (transmits only a red light component), a dichroic mirror 307 that reflects only the green light component, a dichroic mirror 308 that reflects only the blue light component (a mirror reflecting the blue light component), and condensing lenses 310, 311, 312, 313, and 314.

The liquid crystal light valve 25 includes the liquid crystal panel 1B. The liquid crystal light valves 24 and 26 have the same structure as that of the liquid crystal light valve 25. The liquid crystal panels 1B provided in the liquid crystal light valves 24, 25, and 26 are connected to a driving circuit (not shown).

In the projection display apparatus 300, the dichroic prism 21 and the projection lens 22 form an optical block 20. In addition, a display unit 23 includes the optical block 20 and the liquid crystal light valves 24, 25, and 26 fixed to the dichroic prism 21.

Next, the operation of the projection display apparatus 300 will be described below.

A white light component (a white light beam) emitted from a light source 301 passes through the integrator lenses 302 and 303. The light intensity (luminance distribution) is made uniform by the integrator lenses 302 and 303. It is preferable that the white light component emitted from the light source 301 have a relatively high light intensity. In this way, it is possible to improve the resolution of an image formed on a screen 320. Further, since the projection display apparatus 300 includes the liquid crystal panel 1B having high light resistance, it is possible to obtain high stability even when light having high intensity is emitted from the light source 301.

The white light component passing through the integrator lenses 302 and 303 is reflected to the left side of FIG. 7 by the mirror 304. A blue light component (B) and a green light component (G) of the reflected light are reflected to the downward direction of FIG. 8 by the dichroic mirror 305. A red light component (R) passes through the dichroic mirror 305.

The red light component passing through the dichroic mirror 305 is reflected to the downward direction of FIG. 8 by the mirror 306. The reflected light is shaped by the condensing lens 310 and is then incident on the red liquid crystal light valve 24.

The green light component of the blue and green light components reflected by the dichroic mirror 305 is reflected to the left side of FIG. 8 by the dichroic mirror 307, and the blue light component passes through the dichroic mirror 307.

The green light component reflected by the dichroic mirror 307 is shaped by the condensing lens 311, and is then incident on the green liquid crystal light valves 25.

The blue light component passing through the dichroic mirror 307 is reflected to the left side of FIG. 8 by the dichroic mirror (or a mirror) 308 and the reflected light is further reflected to the upward direction of FIG. 8 by the mirror 309. The blue light component is shaped by the condensing lenses 312, 313, and 314 and is then incident on the blue liquid crystal light valve 26.

The white light emitted from the light source 301 is separated into the three primary colors of red, green, and blue by a color separating optical system, and the separated light components are guided to the corresponding liquid crystal light valves and are then incident thereon.

In this case, pixels (thin film transistors 173 and pixel electrodes 172 connected to the transistors 173) of the liquid crystal panel 1B provided in the liquid crystal light valve 24 are controlled (are turned on or off), that is, modulated by a driving circuit (a driving unit) operated on the basis of red image signals.

similarly, the green and blue light components are incident on the liquid crystal light valves 25 and 26, respectively, and are modulated by the liquid crystal panels 1B thereof, thereby forming green and blue images. In this case, pixels of the liquid crystal panel 1B of the liquid crystal light valve 25 are controlled by a driving circuit operated on the basis of green image signals. Similarly, pixels of the liquid crystal panel 1B of the liquid crystal light valve 26 are controlled by a driving circuit operated on the basis of blue image signals.

In this way, the red, green and blue light components are respectively modulated by the liquid crystal light valves 24, 25 and 26 to form red, green, and blue images.

The red image formed by the liquid crystal light valve 24, that is, a red light component emitted from the liquid crystal light valve 24 is incident on the dichroic prism 21 through the surface 213 and is reflected to the left side of FIG. 8 by the dichroic mirror surface 211. Then, the reflected light passes through the dichroic mirror surface 212, and is emitted from the emission surface 216.

The green image formed by the liquid crystal light valve 25, that is, the green light component emitted from the liquid crystal light valve 25 is incident on the dichroic prism 21 through the surface 214. Then, the incident light passes through the dichroic mirror surfaces 211 and 212 and is then emitted from the emission surface 216.

The blue image formed by the liquid crystal light valve 26, that is, the blue light component emitted from the liquid crystal light valve 26 is incident on the dichroic prism 21 through the surface 215 and is reflected to the left side of FIG. 8 by the dichroic mirror surface 212. Then, the reflected light passes through the dichroic mirror surface 21, and is then emitted from the emission surface 216.

As described above, the red, green and blue light components emitted from the liquid crystal light valves 24, 25, and 26, that is, the red, green, and blue images respectively formed by the liquid crystal light vales 24, 25, and 26 are synthesized into a color image by the dichroic prism 21. The color image is projected (enlarged and projected) onto the screen 320 placed at a predetermined position by the projection lens 22.

In this embodiment, the projection display apparatus 300 includes three liquid crystal light valves, and the liquid crystal panels 1B of the invention are applied to the three liquid crystal light valves. However, at least one of the three liquid crystal light valves may be composed of the liquid crystal panel 1B. In this case, it is preferable that the liquid crystal panel 1B be applied to the blue liquid crystal light valve.

In addition to the personal computer (the portable personal computer) shown in FIG. 5, the cellular phone shown in FIG. 6, the digital still camera shown in FIG. 7, and the projection display apparatus shown in FIG. 8, the electronic apparatus of the invention includes, for example, a television set, a video camera, a view-finder-type or monitor-direct-view-type videotape recorder, a car navigation system, a pager, an electronic organizer (includes a communication function), an electronic dictionary, an electronic calculator, an electronic game machine, a word processor, a workstation, a television phone, a security television monitor, an electronic binoculars, a POS terminal, and apparatuses equipped with touch panels (for example, an automatic teller machine of a financial institution and an automatic ticket machine), medical instruments (for example, an electronic thermometer, an electronic sphygmomanometer, an electronic blood-sugar measuring instrument, an electrocardiograph, an ultrasonic diagnostic apparatus, and a display apparatus for an endoscope), a fish detector, various measuring instruments, measuring gauges (for example, gauges for a vehicle, an airplane, and a ship), and a flight simulator. In addition, it goes without saying that the liquid crystal panel of the invention can be applied to display units or monitors of these electronic apparatuses.

The method of treating the inorganic oxide film, the electronic device substrate, the method of manufacturing the electronic device substrate, the liquid crystal panel, and the electronic apparatus according to the invention have been described above with reference to the drawings. However, the invention is not limited thereto.

For example, one or more processes may be added to the method of treating the inorganic oxide film and the method of manufacturing the electronic device substrate.

Further, the method of treating the inorganic oxide film according to the invention can be applied to various types of inorganic oxide films.

For example, in the electronic device substrate, the liquid crystal panel, and the electronic apparatus according to the invention, the structure of the components can be replaced with any structure capable of exhibiting the same functions as those of the components, or an arbitrary structure can be added to the structure of the invention.

Furthermore, the electronic device substrate of the invention can be applied to a liquid crystal panel in which a pair of electrodes for applying a voltage to the liquid crystal layer is provided on the same substrate, in addition to the liquid crystal panel described in the above-mentioned embodiment.

Further, in the above-mentioned embodiment, the electronic device substrate of the invention is applied to the liquid crystal panel, but the invention is not limited thereto. For example, the electronic device substrate can also be applied to an organic transistor. In this case, the use of the electronic device substrate makes it possible to regulate the arrangement direction of an organic semiconductor layer and thus to improve carrier mobility.

### EXAMPLES

Next, examples of the invention will be described below.

Manufacture of Electronic Device Substrate

(Sample No. 1)

1A: First, a glass substrate (having a size of 2.5 cm×2.5 cm) is prepared, and the glass substrate is set in a vapor deposition apparatus, with a surface inclined at an angle of 50° with respect to a vapor deposition source.

Then, the pressure of the vapor deposition apparatus is reduced (1×10⁻⁴ Pa) to perform oblique deposition of SiO₂, thereby manufacturing a substrate having an oblique deposition film (an inorganic oxide film).

In the oblique deposition film, pores are formed at an angle of about 70° with respect to the upper surface of the glass substrate.

2A: Next, the substrate having the oblique deposition film formed thereon is heated at a temperature of 200° C. for 90 minutes in a clean oven, and the heated substrate is left under the dry nitrogen atmosphere.

3A: A mixed solution (a weight ratio=80:20) of 1-octanol (primary alcohol) and 2-propanol (secondary alcohol) is prepared, and ionic impurities thereof are removed by using a filter. Then, water contained in the mixed solution is removed by nitrogen bubbling, thereby adjusting a treatment liquid.

4A: Next, the substrate having the oblique deposition film formed thereon is carried into the processing apparatus shown in FIG. 3 and is then arranged in a vessel (made of poly-tetrafluoroethylene), with the oblique deposition film facing upward.

Then, a chamber is closed, and the prepared treatment liquid is supplied into the vessel such that the substrate having the oblique deposition film is dipped into the treatment liquid.

5A: In the process 4A, the pressure of the chamber is reduced to 100 Pa.

In this way, gas in the pores of the oblique deposition film is substituted for the treatment liquid. That is, the treatment liquid is infiltrated into the pores.

6A: Next, the surplus treatment liquid is discharged from the vessel, and the pressure of the chamber is reduced to 133 Pa (1 Torr). Then, the substrate is heated at a temperature of 150° C. for one hour.

In this way, 1-octanol and 2-propanol are chemically bonded to the surface of the oblique deposition film and the inner surfaces of the pores.

7A: After the heating is finished, a cooling operation is performed on the substrate under the reduced pressure.

In this way, an electronic device substrate is obtained.

The obtained alignment film has an average thickness of 45 nm.

In addition, the mole ratio of 1-octanol to 2-propanol chemically bonded to the vicinity of the surface of the oblique deposition film is 70:30. This is confirmed by a time-of-flight secondary ion mass spectrometer (TOF-SIMS analysis) (which is similarly applied to the following processes).

(Sample No. 2)

1B: First, the same process as the process 1A is performed.

1B: Then, the same process as the process 2A is performed.

3B: Subsequently, 1-octanol (a primary alcohol) is dissolved in diethyl ether (a solvent), and ionic impurities thereof are removed by using a filter. Then, a very small amount of water contained therein is removed by nitrogen bubbling, thereby adjusting a first treatment liquid.

The concentration of 1-octadecanol in the first treatment liquid is adjusted to 90 vol %.

4B: The first treatment liquid is applied onto the oblique deposition film by a spin coating method, and is then dried.

5B: Then, the substrate is heated at a temperature of 150° C. for one hour under atmospheric pressure.

In this way, 1-octadecanol is chemically bonded to the vicinity of the surface of the oblique deposition film.

6B: 2-propanol (secondary alcohol) is prepared, and ionic impurities thereof are removed by using a filter. Then, a very small amount of water contained therein is removed by nitrogen bubbling, thereby adjusting a second treatment liquid.

7B: Next, the same process as the process 4A is performed.

8B: Then, the same process as the process 5A is performed.

In this way, gas in the pores of the oblique deposition film is substituted for the second treatment liquid. That is, the second treatment liquid is infiltrated into the pores.

9B: Subsequently, the same process as the process 6A is performed.

In this way, 2-propanol is chemically bonded to the surface of the oblique deposition film and the inner surfaces of the pores.

10B: The same process as the process 7A is performed.

In this way, an electronic device substrate is obtained.

The obtained alignment film has an average thickness of 45 nm.

In addition, the mole ratio of 1-octadecanol to 2-propanol chemically bonded to the vicinity of the surface of the oblique deposition film is 80:20.

(Sample No. 3)

In a sample No. 3, an electronic device substrate is manufactured in the same manner as that in the sample No. 2 except that cholesterol is used as the primary alcohol and toluene is used as a solvent to manufacture an electronic device substrate.

An alignment film obtained in the sample No. 3 has an average thickness of 46 nm.

In addition, the mole ratio of cholesterol to 2-propanol chemically bonded to the vicinity of the surface of the oblique deposition film is 75:25.

(Sample No. 4)

In a sample No. 4, an electronic device substrate is manufactured in the same manner as that in the sample No. 2 except that 1-octadecanol and cholesterol is used as the primary alcohol and toluene is used as a solvent to manufacture an electronic device substrate.

The mole ratio of 1-octadecanol to cholesterol is 50:50.

An alignment film obtained in this sample has an average thickness of 48 nm.

In addition, the weight ratio of 1-octadecanol to cholesterol to 2-propanol chemically bonded to the vicinity of the surface of the oblique deposition film is 40:35:25.

(Sample No. 5)

In a sample No. 5, an electronic device substrate is manufactured in the same manner as that in the sample No. 1 except that, instead of SiO₂, Al₂O₃ is deposited to manufacture a substrate having an oblique deposition film (inorganic oxide film) formed thereof, thereby manufacturing an electronic device substrate.

An alignment film obtained in this sample has an average thickness of 45 nm.

In addition, the mole ratio of 1-octadecanol to 2-propanol chemically bonded to the vicinity of the surface of the oblique deposition film is 70:30.

(Sample No. 6)

In a sample No. 6, an electronic device substrate is manufactured in the same manner as that in the sample No. 1 except that 1-octadecanol is independently used as alcohol to manufacture an electronic device substrate.

An alignment film obtained in this sample has an average thickness of 45 nm.

(Sample No. 7)

In a sample No. 7, an electronic device substrate is manufactured in the same manner as that in the sample No. 1 except that 2-propanol is independently used as alcohol to manufacture an electronic device substrate.

An alignment film obtained in this sample has an average thickness of 42 nm.

(Sample No. 8)

In a sample No. 8, an electronic device substrate is manufactured in the same manner as that in the sample No. 1 except that the pressure reducing step is omitted in the process 5A and the process 6A is omitted.

An alignment film obtained in this sample has an average thickness of 40 nm.

(Sample No. 9)

In a sample No. 9, an electronic device substrate is manufactured in the same manner as that in the sample No. 1 except that the pressure reducing step is omitted in the process 5A.

An alignment film obtained in this sample has an average thickness of 45 nm.

(Sample No. 10)

In a sample No. 10, an electronic device substrate is manufactured in the same manner as that in the sample No. 5 except that the pressure reducing step is omitted in the process 5A and the process 6A is omitted.

An alignment film obtained in this sample has an average thickness of 40 nm.

(Sample No. 11)

In a sample No. 11, an electronic device substrate is manufactured in the same manner as that in the sample No. 5 except that the pressure reducing step is omitted in the process 5A.

An alignment film obtained in this sample has an average thickness of 45 nm.

2. Evaluation of Alcohol Bonding Rate

The electronic device substrates of the sample Nos 1, 5, and 8 to 11 are heated at a temperature of 200° C., and gas generated at the time is analyzed by using a gas chromatograph-mass spectrometer (GC-MS; for example ‘GC-MS QP5050A’ manufactured by Shimadzu Corporation).

From a chart obtained by the GC-MS, the amounts of propylene and octane generated from the electronic device substrates of each sample are calculated by adding up the areas of peaks derived from propylene.

The amounts of the generated propylene and octane are proportional to the amounts of 2-propanol and 1-octanol chemically bonded to the oblique deposition film, respectively.

The results are shown in the following table 1.

TABLE 1

| | | Treatment by | | | |
|---|---|---|---|---|---|
| | | treatment liquid | | | |
| | Ingredients | Reduction of | Execution of | Amount of | |
| | of oblique | pressure at | heating at the | generated gas | |
| | deposition | the time of | time of | (relative value) | |
| Sample No. | film | dipping | dipping | Propylene | Octane |
| 1 (example) | SiO₂ | Executed | Executed | 3.5 | 1.5 |
| 8 (comparative example) | | Not executed | Not executed | Smaller than | Smaller |
| | | | | 0.1 | than 0.1 |
| 9 (comparative example) | | Not executed | Executed | 1.0 | 1.0 |
| 5 (example) | Al₂O₃ | Executed | Executed | 3.2 | 1.1 |
| 10 (comparative example) | | Not executed | Not executed | Smaller than | Smaller |
| | | | | 0.1 | than 0.1 |
| 11 (comparative example) | | Not executed | Executed | 1.0 | 1.0 |
| 1 (example) | SiO₂ | Executed | Executed | 3.5 | 1.5 |
| 8 (comparative example) | | Not executed | Not executed | Smaller than | Smaller |
| | | | | 0.1 | than 0.1 |
| 9 (comparative example) | | Not executed | Executed | 1.0 | 1.0 |
| 5 (example) | Al₂O₃ | Executed | Executed | 3.2 | 1.1 |
| 10 (comparative example) | | Not executed | Not executed | Smaller than | Smaller |
| | | | | 0.1 | than 0.1 |
| 11 (comparative example) | | Not executed | Executed | 1.0 | 1.0 |

In the table 1, the amount of propylene and octane generated from the electronic device substrate of the sample No. 9 is regarded as a value of ‘1.0’, and the amounts of propylene and octane generated from the electronic device substrates of the sample Nos. 1 and 8 are represented by relative values to the value.

In addition, the amount of propylene and octane generated from the electronic device substrate of the sample No. 11 is regarded as a value of ‘1.0’, and the amounts of propylene and octane generated from the electronic device substrates of the sample Nos. 5 and 10 are represented by relative values to the value.

As can be apparently seen from the table 1, in the sample Nos. 9 and 11, a heat treatment makes it possible to increase the amount of alcohol chemically bonded to the oblique deposition film, as compared with the sample Nos. 8 and 10 in which the oblique deposition film is simply dipped into the treatment liquid.

In addition, the table 1 clearly shows that reducing pressure when the oblique deposition film is dipped into alcohol (the sample Nos. 1 and 5) makes it possible to increase the amount of alcohol chemically bonded to the oblique deposition film. This is because the reduction of pressure causes alcohol to be deeply infiltrated into the pores of the oblique deposition film, so that the amount of alcohol chemically bonded to the inner surfaces of the oblique deposition film increases.

3. Manufacture of Liquid Crystal Panel

### Example 1

First, the same process as that performed in the sample No. 1 is executed to manufacture two electronic device substrates.

Then, a thermosetting adhesive (‘ML3804P’ manufactured by Nippon Kayaku Co., Ltd.) is printed on the peripheral portion of a surface of one of the electronic device substrates having an alignment film formed thereon, except a liquid crystal injection hole, and the substrates are heated at a temperature of 80° C. for ten minutes to remove a solvent.

The thermosetting adhesive is an epoxy resin containing silica beads having a diameter of about 3 μm dispersed therein.

Then, the other substrate is pressed against the one substrate, with its inner surface having an alignment film formed thereon facing the one substrate, and the two substrates are heated at a temperature of 140° C. for an hour, thereby bonding the two substrates.

Subsequently, the two substrates are arranged such that the alignment directions of the alignment films are reverse to each other.

Next, fluorine-based liquid crystal having negative dielectric anisotropy (‘MLC-6610’ manufactured by Merck) is injected into a space formed between the two substrates bonded to each other through the liquid crystal injection hole by a vacuum injection method.

Then, an acryl-based UV adhesive (‘LDP-204’ manufactured by Henkel Japan Ltd.) is applied onto the liquid crystal injection hole, and a UV having a wavelength of 365 nm is radiated onto the UV adhesive with an energy of 3000 mJ/cm² to harden it, thereby sealing the liquid crystal injection hole.

In this way, a liquid crystal panel is manufactured.

### Example 2

A liquid crystal panel is manufactured in the same manner as that in the example 1 except that the electronic device substrate of the sample No. 2 is used.

### Example 3

A liquid crystal panel is manufactured in the same manner as that in the example 1 except that the electronic device substrate of the sample No. 3 is used.

### Example 4

A liquid crystal panel is manufactured in the same manner as that in the example 1 except that the electronic device substrate of the sample No. 4 is used.

### Example 5

A liquid crystal panel is manufactured in the same manner as that in the example 1 except that the electronic device substrate of the sample No. 5 is used.

### Comparative Example 1

A liquid crystal panel is manufactured in the same manner as that in the example 1 except that the electronic device substrate of the sample No. 6 is used.

### Comparative Example 2

A liquid crystal panel is manufactured in the same manner as that in the example 1 except that the electronic device substrate of the sample No. 7 is used.

### Comparative Example 3

A liquid crystal panel is manufactured in the same manner as that in the example 1 except that the electronic device substrate of the sample No. 8 is used.

### Comparative Example 4

A liquid crystal panel is manufactured in the same manner as that in the example 1 except that the electronic device substrate of the sample No. 9 is used.

### Comparative Example 5

A liquid crystal panel is manufactured in the same manner as that in the example 1 except that the electronic device substrate of the sample No. 10 is used.

### Comparative Example 6

A liquid crystal panel is manufactured in the same manner as that in the example 1 except that the electronic device substrate of the sample No. 11 is used.

4. Light Resistance Test and Alignment Stability Test of Liquid Crystal Panel

In the light resistance test, each liquid crystal panel manufactured in the examples and the comparative examples is set as the blue liquid crystal light valve of the projection display apparatus shown in FIG. 8. Then, a light source is continuously turned on while the surface of the liquid crystal panel is being maintained at a temperature of 55° C. The time required until display abnormality occurs is measured.

A 130WUHP lamp (manufactured by Philips Ltd.) is used as a light source.

In the alignment stability test, each liquid crystal panel manufactured in the examples and the comparative examples is placed in a constant temperature bath of 80° C. for 100 hours. Then, the width of a region where liquid crystal is abnormally aligned at the time of sealing is measured. When the initial width of the region where liquid crystal is abnormally aligned is regarded as a value of ‘1.0’, the time required until the width of the abnormal region of the liquid crystal panel placed in the constant temperature bath is ‘2.0’ is measured.

The results are shown in the following table 2.

TABLE 2

| | | | | | Time required | |
|---|---|---|---|---|---|---|
| | Ingredient | | | | until display | Results of |
| | of oblique | Treatment by treatment liquid | | | abnormality | alignment |
| | deposition | Primary | Secondary | Number of | occurs | stability |
| | film | alcohol | alcohol | processes | (relative value) | test |
| Example 1 | SiO₂ | 1-octanol | 2-propanol | 1 | 5.2 | ◯ |
| Example 2 | | 1-octadecanol | 2-propanol | 2 | 4.9 | ◯ |
| Example 3 | | cholesterol | 2-propanol | 2 | 5.1 | ◯ |
| Example 4 | | 1-octadecanol + | 2-propanol | 2 | 4.8 | ⊚ |
| | | cholesterol | | | | |
| Comparative | | 1-octanol | | 1 | 3.3 | ◯ |
| example 1 | | | | | | |
| Comparative | | 2-propanol | | 1 | 4.9 | Δ |
| example 2 | | | | | | |
| Comparative | | 1-octanol | 2-propanol | 1 | 0.7 | X |
| example 3 | | | | | | |
| Comparative | | 1-octanol | 2-propanol | 1 | 1.0 | Δ |
| example 4 | | | | | | |
| Example 5 | Al₂O₃ | 1-octanol | 2-propanol | 1 | 5.6 | ◯ |
| Comparative | | 1-octanol | 2-propanol | 1 | 0.6 | X |
| example 5 | | | | | | |
| Comparative | | 1-octanol | 2-propanol | 1 | 1.0 | Δ |
| example 6 | | | | | | |

In the table 2, when the time required until display abnormality occurs in the liquid crystal panel of the comparative example 4 is regarded as a value of ‘1.0’, the time required until display abnormality occurs in the liquid crystal panels of the examples 1 to 4 and the comparative examples 1 to 3 is represented by relative values to the value.

In addition, when the time required until display abnormality occurs in the liquid crystal panel of the comparative example 6 is regarded as a value of ‘1.0’, the time required until display abnormality occurs in the liquid crystal panels of the example 5 and the comparative example 5 is represented by relative values to the value.

As shown in the table 2, in the liquid crystal panels of the examples 1 to 4, the time required until display abnormality occurs is longer than that in the liquid crystal panels of the comparative examples 1, 3, and 4. Also, in the liquid crystal panel of the example 5, the time required until display abnormality occurs is longer than that in the liquid crystal panels of the comparative examples 5 and 6.

This is because alcohol having a lower molecular weight is deeply infiltrated into the pores of the oblique deposition film, so that the amount of alcohol chemically bonded to the inner surfaces of the oblique deposition film increases.

In the alignment stability test shown in the table 2, the symbol ‘x’ represents that the time required until the width of the abnormal region of the liquid crystal panel placed in the constant temperature bath is a value of ‘2.0’ is shorter than 300 hours. The symbol ‘Δ’ represents that the time required until the width of the abnormal region is the value of ‘2.0’ is equal to or longer than 300 hours and shorter than 600 hours. The symbol ‘◯’ represents that the time required until the width of the abnormal region is the value of ‘2.0’ is equal to or longer than 600 hours and shorter than 1000 hours. The symbol ‘⊙’ represents that the width of the abnormal region does not increase even when the liquid crystal panel is left in the constant temperature bath equal to or more than 1000 hours.

The comparison between the liquid crystal panels of the examples 1 to 4 and the liquid crystal panel of the comparative example 2 shows that the use of alcohol having a high molecular weight makes it possible to improve the alignment stability. It is considered that this is a result of a rise in vertical anchoring force with respect to the liquid crystal molecules of the alcohol having a high molecular weight.

Further, the fluorine-substituted products of various kinds of alcohols are used as alcohols to manufacture the same electronic device substrate and liquid crystal panel as described above, and the evaluation thereof is made in the same manner as described above. In this case, the same results as described above are also obtained.

What is claimed is:

1. A method of treating an inorganic oxide film comprising:
dipping an obliquely deposited inorganic oxide film having a plurality of pores formed therein into a treatment liquid containing at least a primary alcohol and a secondary alcohol, the secondary alcohol having a lower molecular weight than that of the primary alcohol;
infiltrating the treatment liquid into the pores of the inorganic oxide film by reducing a pressure of a space where the treatment liquid is provided; and
chemically bonding the treatment liquid to a surface of the inorganic oxide film and inner surfaces of the pores.

2. A method of treating an inorganic oxide film comprising:
bringing a first treatment liquid containing at least a primary alcohol into contact with an obliquely formed inorganic oxide film having a plurality of pores therein;
chemically bonding the alcohol of the first treatment liquid to a surface of the inorganic oxide film;
dipping the inorganic oxide film into a second treatment liquid containing at least a secondary alcohol having a lower molecular weight than that of the primary alcohol;
infiltrating the second treatment liquid into the pores of the inorganic oxide film by reducing a pressure of a space where the second treatment liquid is provided; and
chemically bonding the secondary alcohol of the second treatment liquid to the surface of the inorganic oxide film and inner surfaces of the pores.

3. An electronic device substrate comprising:
a substrate; and
an alignment film formed on a surface of the substrate,
wherein the alignment film includes an obliquely formed inorganic oxide film that includes at least a primary alcohol and a secondary alcohol that is chemically bonded to a surface thereof that includes a plurality of pores therein and to an inner surface of each of the pores, the secondary alcohol having a lower molecular weight than that of the primary alcohol.

4. The electronic device substrate according to claim 3,
wherein a mole ratio of the primary alcohol to the secondary alcohol in a vicinity of the surface of the inorganic oxide film is in the range of 50:50 to 95:5.

5. A method of manufacturing an electronic device substrate including a substrate and an alignment film formed on a surface of the substrate, comprising:
forming an inorganic oxide film having a plurality of pores formed therein on the surface of the substrate by an oblique deposition method;
dipping the substrate having the inorganic oxide film formed thereon into a treatment liquid containing at least a primary alcohol and a secondary alcohol, the secondary alcohol having a lower molecular weight than that of the primary alcohol;
infiltrating the treatment liquid into the pores of the inorganic oxide film by reducing a pressure of a space where the treatment liquid is provided; and
chemically bonding the alcohols of the treatment liquid to a surface of the inorganic oxide film and inner surfaces of the pores to form the alignment film.

6. The method of manufacturing an electronic device substrate according to claim 5,
wherein a mole ratio of the primary alcohol to the secondary alcohol of the treatment liquid is in the range of 70:30 to 90:10.

7. The method of manufacturing an electronic device substrate according to claim 5,
wherein, in the infiltrating of the treatment liquid, the pressure of the space is in the range of 1×10⁻⁴ Pa to 1×10⁴ Pa.

8. The method of manufacturing an electronic device substrate according to claim 5,
wherein the substrate is heated to chemically bond the inorganic oxide film to the alcohols of the treatment liquid.

9. The method of manufacturing an electronic device substrate according to claim 8,
wherein the substrate is heated at a temperature in the range of 80° C. to 250° C.

10. The method of manufacturing an electronic device substrate according to claim 8,
wherein the substrate is heated for 20 to 180 minutes.

11. A method of manufacturing an electronic device substrate including a substrate and an alignment film formed on a surface of the substrate, comprising:
forming an inorganic oxide film having a plurality of pores formed therein on the surface of the substrate by an oblique deposition method;
bringing a first treatment liquid containing at least a primary alcohol into contact with the inorganic oxide film;
chemically bonding the primary alcohol of the first treatment liquid to a surface of the inorganic oxide film;
dipping the substrate having the inorganic oxide film formed thereon into a second treatment liquid containing at least a secondary alcohol, the secondary alcohol having a lower molecular weight than that of the primary alcohol;
infiltrating the second treatment liquid into the pores of the inorganic oxide film by reducing a pressure of a space where the second treatment liquid is provided; and
chemically bonding at least the secondary alcohol of the second treatment liquid to the surface of the inorganic oxide film and inner surfaces of the pores to form the alignment film.

12. The method of manufacturing an electronic device substrate according to claim 11,
wherein the first treatment liquid further includes a tertiary alcohol which has a higher molecular weight than that of the secondary alcohol and differs from the primary alcohol and the secondary alcohol in kind.

13. The method of manufacturing an electronic device substrate according to claim 11,
wherein the substrate is heated to chemically bond the inorganic oxide film to the primary alcohol of the first treatment liquid.

14. The method of manufacturing an electronic device substrate according to claim 13,
wherein the substrate is heated at a temperature in the range of 80° C. to 250° C.

15. The method of manufacturing an electronic device substrate according to claim 13,
wherein the substrate is heated for 20 to 180 minutes.

16. The method of manufacturing an electronic device substrate according to claim 11,
wherein, in the infiltrating of the second treatment liquid, the pressure of the space is in the range of 1×10⁻⁴ Pa to 1×10⁴ Pa.

17. The method of manufacturing an electronic device substrate according to claim 11,
wherein the substrate is heated to chemically bond the inorganic oxide film to the secondary alcohol of the second treatment liquid.

18. The method of manufacturing an electronic device substrate according to claim 17,
wherein the substrate is heated at a temperature in the range of 80° C. to 250° C.

19. The method of manufacturing an electronic device substrate according to claim 17,
wherein the substrate is heated for 20 to 180 minutes.

20. The method of manufacturing an electronic device substrate according to claim 5,
wherein the primary alcohol has 5 to 30 carbon atoms.

21. The method of manufacturing an electronic device substrate according to claim 5,
wherein the primary alcohol is at least one selected from the group consisting of an aliphatic alcohol, an alicyclic alcohol, and a fluorine-substituted product thereof.

22. The method of manufacturing an electronic device substrate according to claim 21,
wherein the alicyclic alcohol has a steroid skeleton.

23. The method of manufacturing an electronic device substrate according to claim 5,
wherein the secondary alcohol has 1 to 4 carbon atoms.

24. The method of manufacturing an electronic device substrate according to claim 5,
wherein the secondary alcohol is an aliphatic alcohol or a fluorine-substituted product thereof.

25. The method of manufacturing an electronic device substrate according to claim 5,
wherein, when the number of carbon atoms of the primary alcohol is referred to as A and the number of carbon atoms of the secondary alcohol is referred to as B, and A-B is equal to or larger than 3.

26. A liquid crystal panel comprising:
the electronic device substrate according to claim 3; and
a liquid crystal layer which is provided on a surface of the substrate opposite to the alignment film.

27. A liquid crystal panel comprising:
a pair of the electronic device substrates according to claim 3; and
a liquid crystal layer which is interposed between the alignment films of the pair of electronic device substrates.

28. An electronic apparatus comprising the liquid crystal panel according to claim 26.
